(19) United States
(12) Patent Application Publication
(10) Pub. No.: US 2017/0147610 A1
(43) Pub. Date: May 25, 2017

(54) IMAGE-BASED SEARCH ENGINE

(71) Applicant: Via Capitale, Laval (CA)

(72) Inventor: Benjamin BARRÉ, Montreal (CA)

(21) Appl. No.: 15/269,284

(22) Filed: Sep. 19, 2016

Related U.S. Application Data
(60) Provisional application No. 62/259,436, filed on Nov. 24, 2015.

(51) Int. Cl. G06F 17/30; G06F 3/0482; G06F 17/22; G06F 3/0481

(52) U.S. Cl. CPC G06F 17/30277; G06F 17/30268; G06F 3/04812; G06F 3/0482; G06F 17/2235; G06F 17/2247

(57) ABSTRACT

A computer-implemented method implemented between a server and a user device for performing an image-based search in a database comprising unique entries to which are respectively associated a unique key, the unique entries having associated thereto images which each have a tag representative of a category related to the unique entries. The method comprises the user device displaying a search GUI comprising a graphic query field; receiving from the user a graphic query object (GQO); and transmitting to the server the GQO. The method comprises the server searching the database for a tag matching to the GQO and selecting only matching images; and transmitting to the user device interface code comprising the selected images. The method comprises the user device displaying an image GUI comprising a mosaic of the selected images. Accordingly, each image comprises a hyperlink to a unique entry from the database.

### CROSS-REFERENCE TO RELATED APPLICATION

This application claims priority from US provisional patent applications U.S. 62/259,436 filed Nov. 24, 2015, the specification of which is hereby incorporated herein by reference in its entirety.

### BACKGROUND

(a) Field

The subject matter disclosed generally relates to the field of online platforms, software and associated hardware. More particularly, the subject matter disclosed relates to a method, an application and a server accessed via Internet for performing image-based searches online.

(b) Related Prior Art

In the field of web platforms and associated applications used for searching, and more particularly in relation with property shopping web sites, there is a plurality of web sites for shopping properties based on prices, location, etc.

These web platforms provide solution to filter the property to browse, as to browse visually the properties. The filtering queries are usually based on the value/price of the properties, the location of the properties, the age of the properties, the number of rooms of the property, the nature of the different rooms of the properties, or in other words generic fields that match more or less all of the properties with simple yes/no field filings and numeral field filing.

Nevertheless, the human nature extends the property browsing over these criteria. Additional criteria to match the specific desires of property browsers may be based on needs that cannot be described with the above fields, and that are basically what they feel to be “visually appealing”. Therefore, there is for improvement in the field that would respond better to the human nature of property browsing.

Accordingly, there is therefore a need for new devices, software and methods that responds to these needs.

### SUMMARY

According to an embodiment, there is provided a computer-implemented method for performing, on a server, an image-based search in a database comprising unique entries to which are respectively associated a unique key, the unique entries having associated thereto images which each have a tag representative of a feature characterizing the unique entries. The method comprises:
upon reception of an access request to a search graphical user interface from a user device under control of a user, transmitting querying code to the user device to display the search graphical user interface comprising a graphic query field; and
upon reception, via the graphic query field, of a query request with an embedded graphic query object indicative of a feature of interest characterizing the unique entries:
   identifying images from the database having a tag matching the embedded graphic query object and hence the feature of interest; and
   transmitting interface code to the user device to display an image graphical user interface comprising a mosaic including only the images which were identified in identifying step performed by the server;
wherein each one of the images in the mosaic comprises a hyperlink to a unique entry from the unique entries and further wherein images associated to a unique entry are exclusive to that unique entry.

According to an aspect, the method further comprises:
performing an algorithm; and
determining a display characteristic to be associated with the images of the mosaic,
wherein the display characteristic determines one of an order and a size of the images for displaying in the mosaic.

According to an aspect, the method further comprises:
receiving interaction content, each of the interaction content being associated with a single image; and
using the interaction content and as an input of the algorithm.

According to an aspect, the interaction content comprises an active interaction content comprising one of a comment, a like comment, a dislike comment, a rating and a social network share request.

According to an aspect, the interaction content comprises a passive interaction content based on at least one of a number of views, a number of hovering over with a pointing device, a duration of hovering over with the pointing device and a duration of display of the single image having the associated passive interaction content on a user device.

According to an aspect, the method further comprises:
receiving a social network command associated with a first one of the images for sharing the first one of the images on a social network; and
transmitting, to a server of the social network, a sharing command comprising the first one of the images and the hyperlink associated to the first one of the images.

According to an aspect, the method further comprises:
receiving one of social network account data and login data having social network account data associated therewith; and
including in the sharing command the social network account data.

According to an aspect, the method further comprises:
receiving one of social network account data and login data having social network account data associated therewith; and
including the social network account data in the sharing command.

According to an aspect, the method further comprises:
selecting images from the database from the images which were identified having a tag matching the embedded graphic query object as a subset of images; and
associating highlight markings with the images which are part of the subset of images;
wherein the images which are part of the subset of images and the images not part of the subset of images are displayed differently in the mosaic.

According to an embodiment, there is provided a computer-implemented method for performing, on a user device under control of a user and in communication with a server, an image-based search in a database comprising unique entries to which are respectively associated a unique key, the unique entries having associated thereto images which each have a tag representative of a feature of interest characterizing the unique entries, the method comprising:
displaying a search graphical user interface comprising a graphic query field;
receiving from the user, identification of a graphic query object provided through the graphic query field;
displaying an image graphical user interface comprising a mosaic comprising images;
wherein the images of the mosaic are a selection of only the images that were identified from the database having a tag matching the graphic query object and hence the feature of interest, and
wherein each image in the mosaic comprises a hyperlink to a unique entry from the unique entries and further wherein images associated to a unique entry are exclusive to that unique entry.

According to an aspect, the method further comprises transmitting to the server the graphic query object.

According to an aspect, the method further comprises:
receiving login data from a user; and
transmitting to the server the login data for the user to be logged in;
wherein the database comprises a user section; and
wherein actions performed by the user are registered in the user section of the database.

According to an aspect, the image graphical user interface comprises an interaction control, and wherein the method further comprises:
detecting use of the interaction control associated with a first one of the images from the user; and
displaying an interaction content associated with the first one of the images.

According to an aspect, the method further comprises:
detecting an activation of the hyperlink associated with a first one of the images;
transmitting to the server a signal indicative of the activation of the hyperlink;
receiving, from the server, new page code based on the signal indicative of the activation of the hyperlink; and
displaying a new page using the new page code;
wherein the new page is associated with the first one of the images.

According to an aspect, the method further comprises:
detecting activation of an interaction control associated with a first one of the images;
displaying an interaction interface based of activation of the interaction control;
receiving, from the user, an interaction command; and
transmitting to the server the interaction command to be registered in the database;
wherein the interaction command is one of a comment, a like, a dislike, a ranking and a social network command to share the first one of the images on a social network.

According to an aspect, the method further comprises:
receiving a display configuration command;
displaying, based on the display configuration command, a second image graphical user interface comprising a mosaic of images;
wherein the image graphical user interface presents the mosaic in a first configuration and the second image graphical user interface presents the mosaic in a second configuration different from the first configuration.

According to an aspect, the method further comprises:
monitoring behavior of a pointing device in relation with the image graphical user interface;
triggering activation of a behavior control based on the behavior of the pointing device fulfilling a criterion;
wherein the behavior control is associated with a first one of the images.

According to an embodiment, there is provided a computer-implemented system for performing an image-based search comprising:
a user device for generating an access request for content relatively to an embedded graphic query object and for displaying content associated with the embedded graphic query object;
a database comprising unique entries to which are respectively associated a unique key, the unique entries having associated thereto images which each have a tag representative of a feature of interest characterizing the unique entries;
a remote server in communication with to the user device for identifying images from the database having a tag matching the embedded graphic query object and hence the feature of interest and for transmitting interface code to the user device for displaying on the user device an image graphical user interface comprising a mosaic including only the images which were selected;
wherein each one of the images in the mosaic comprises a hyperlink to a unique entry from the unique entries and further wherein images associated to a unique entry are exclusive to that unique entry.

According to an aspect, the interface code further comprises interaction controls for performing functions under control of a user in association with the images of the mosaic.

According to an aspect, the interaction controls are adapted for the user device to transmit data to the remote server.

According to an embodiment, there is provided a computer-implemented method involving a server in communication with a user device under control of a user, the computer-implemented method for performing an image-based search in a database comprising unique entries to which are respectively associated a unique key, the unique entries having associated thereto images which each have a tag representative of a feature characterizing the unique entries. The method comprises: the user device displaying a search graphical user interface comprising a graphic query field; the user device receiving from the user, an identification of a graphic query object provided through the graphic query field; the user device transmitting to the server the identification of the graphic query object; the server performing an image-based search in the database for identifying images from the database having a tag matching the embedded graphic query object and hence the feature of interest; the server transmitting interface code to the user device comprising a mosaic of images including only the images which were identified; and the user device displaying an image graphical user interface according to the interface code comprising the mosaic; wherein each one of the images in the mosaic comprises a hyperlink to a unique entry from the unique entries and further wherein images associated to a unique entry are exclusive to that unique entry.

According to an embodiment, there is provided an image filtering system for filtering images accessible via an Internet computer network. The image filtering system comprising: a database coupled to the Internet computer network and comprising unique entries to which are respectively associated a unique key, the unique entries having associated thereto the images which each have a tag representative of a feature of interest characterizing the unique entries; a user device under control of a user for displaying a search graphical user interface comprising a graphic query field and an image graphical user interface, the user device receiving from the user, an identification of a graphic query object indicative of a feature of interest characterizing the unique entries and provided through the graphic query field; a server coupled to the user device, the Internet computer network and the database; a logical filtering elements including the feature of interest selected by the user in the graphic query field of the search graphical user interface; a filtering scheme for identifying images from the database having a tag matching the graphic query object and hence the feature of interest; the server applying the filtering scheme on the database using the logical filtering elements to enable the transmitting of interface code to the user device comprising a mosaic only the images which were identified; and the user device displaying the image graphical user interface according to the interface code comprising the mosaic; wherein each one of the images in the mosaic comprises a hyperlink to a unique entry from the unique entries and further wherein images associated to a unique entry are exclusive to that unique entry.

### BRIEF DESCRIPTION OF THE DRAWINGS

Further features and advantages of the present disclosure will become apparent from the following detailed description, taken in combination with the appended drawings, in which:

FIG. 1A is a network architecture in which a computing device operates for performing image-based searches online in accordance with an embodiment;

FIG. 1B is a block diagram illustrating a suitable computing device in which a method for performing image-based searches online may be implemented in accordance with another embodiment;

FIG. 2 is a schematic representation of a first web page (aka a search graphical user interface or a “GUI”) displayed for performing of an image-based search according to an embodiment;

FIG. 3 is a flow chart illustrating the steps or sub-processes performed, according to an embodiment, on a user device in relation with the present method of performing the image-based search online;

FIG. 4 is a schema illustrating a database involved, according to an embodiment, in the present method;

FIG. 5 is a flow chart illustrating the steps or sub-processes performed, according to an embodiment, on a server in relation with the present method;

FIG. 6 is a schematic representation of a query-result web page (aka an image graphical user interface) generated according to an embodiment of the presently described method; and

FIG. 7 is a schematic representation of a property web page generated according to an embodiment.

It will be noted that throughout the appended drawings, like features are identified by like reference numerals.

### DETAILED DESCRIPTION

It is to be noted that “user” or “customer” according to the present disclosure is intended to mean all the users that operate any computing device in connection with the web site or other form in which the service is provided to the users as described below.

It is further to be noted that “web site”, “system” and “platform” are intended to refer to the structure, interface and associated functionalities through which interaction is made with the users using the present solution, and the solution itself, including current data (representation data, login data, user data, properties data, picture, tags, metatags, etc.) permitting the platform to operate properly and therefore allow users to perform the discussed “searching process”.

It is to be noted that the terms “functionality”, “process”, “algorithm”, and “methodology” are used interchangeably in the present description. However, it is understood, that a process for example may comprise one or more sub-processes, and the sub-processes, as said process may be referred with the other terms without departing from the intended hierarchical configuration.

It is to be noted that “image” and “picture” are used interchangeably in the present description. However, it is understood that a “picture” is only one type of “image” and therefore “image” is a broader term than “picture”.

It is further to be noted that the term “web page” is intended to refer to the specific interface displayed to a user, regardless of the mechanisms used to code, generate, communicate and display the web page to the user. Accordingly, the web page may be coded as a HTML document, a generic or Cascading Style Sheet (CSS) in association with provided query results for instance, or a different combination of web content and coding formatting that allows to provide the content as a HTML document, or similar graphical user interface (GUI), on a user device.

Furthermore, “new” web page may also take many forms without departing from its intended scope. New web page may refer to a web page displayed in a browser in replacement of a previous one, a new generated web page in addition to the previous one, or an overlay disposed above the previous one for example.

Furthermore, the term “browser” is used in a broad meaning as a tool, operating environment or system being able to decode and display content; that content depending on data provided by a server (e.g., a remote server).

It is to be noted that “button”, “menu”, “command”, “interactive box” and the like are used interchangeably in the present description. However, it is understood that it refers to a visual interactive component of a user interface potentially having a function (embodied as a control) associated therewith. A common programming language used for such a function/control is JavaScript.

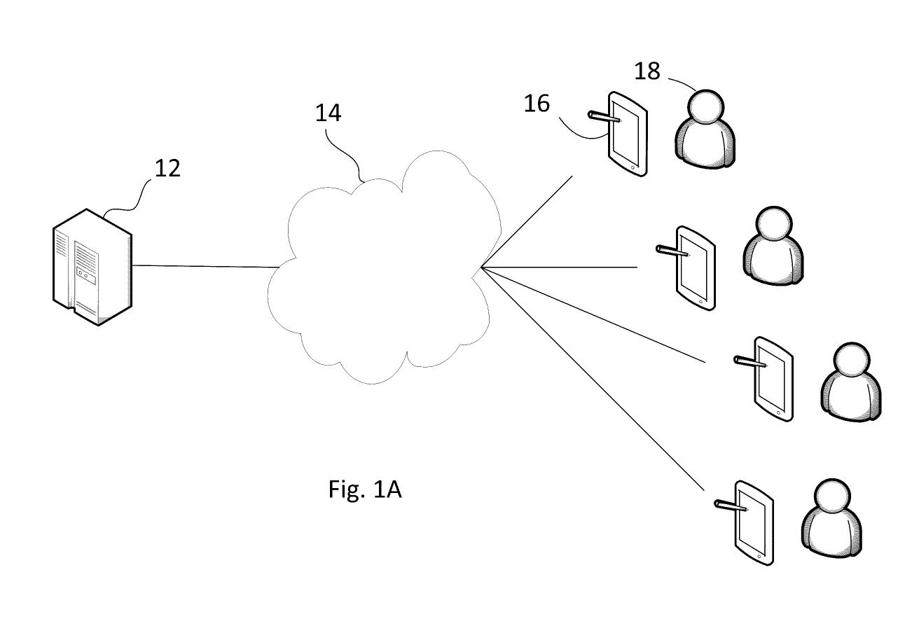

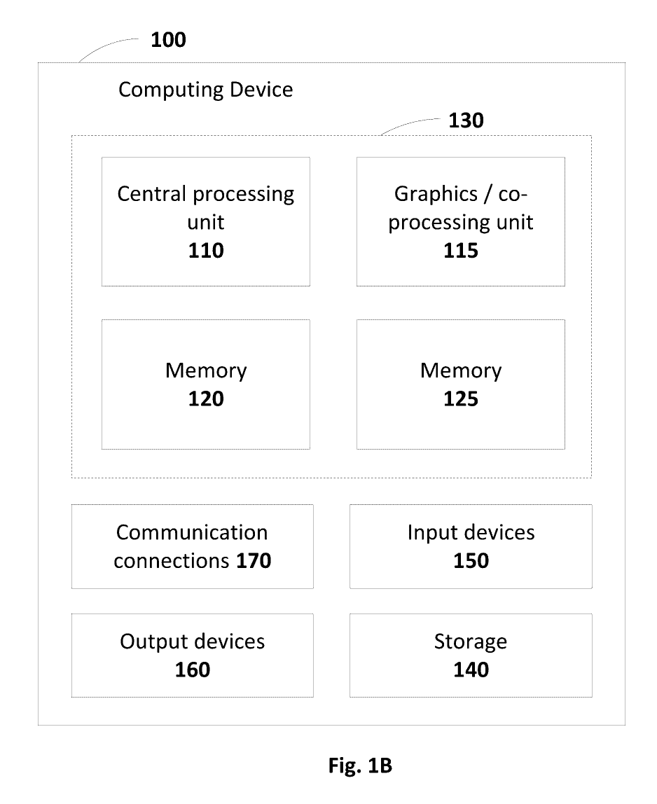

According to an embodiment and referring now to FIGS. 1A and 1B, there is provided a computing device 100 for performing the method for providing the searching functionalities according to an embodiment. The computing device includes a processing unit 110 and a memory 120 which is operatively coupled to the computing device 100 for storing data regarding a plurality of properties. The computing device 100 further includes a memory 125 which is operatively coupled to the processing unit 110 for storing instructions which causes the processing unit 110 to perform the method according to an embodiment. According to another embodiment, the computing device 100 may further comprise an input device 150, such as a keyboard, a mouse or a trackpad (or any other type of pointing device) and/or touchscreen capability (allowing according to instructions processed by the processing unit 110 and displayed on the screen of the computing device 100 to generate soft input buttons).

As shown in FIG. 1A and according to an embodiment, the computing device 100 may consist in one or a plurality of servers 12, performing alone or in combination all the functionalities related to the present method. The computing device 100 is able to exchange, via a communication network 14 such as the Internet, data with user devices 16, illustrated as an exemplary embodiment, mobile devices, which are under control of users 18. Therefore, some aspects related to the method may be performed on the computing device 100 in communication with user device 16, while other aspects related to the method may be performed on user devices 16 in communication with the computing device 100.

According to one embodiment, the computing device 100 may be, without limitation, one or more servers 12, one or more computers, etc. The user devices 16 may be, without limitation, a computer, a laptop, a smartphone, a tablet, a tablet computer, and the like, present or future user-controlled computing devices.

### Web Site—User Perspective

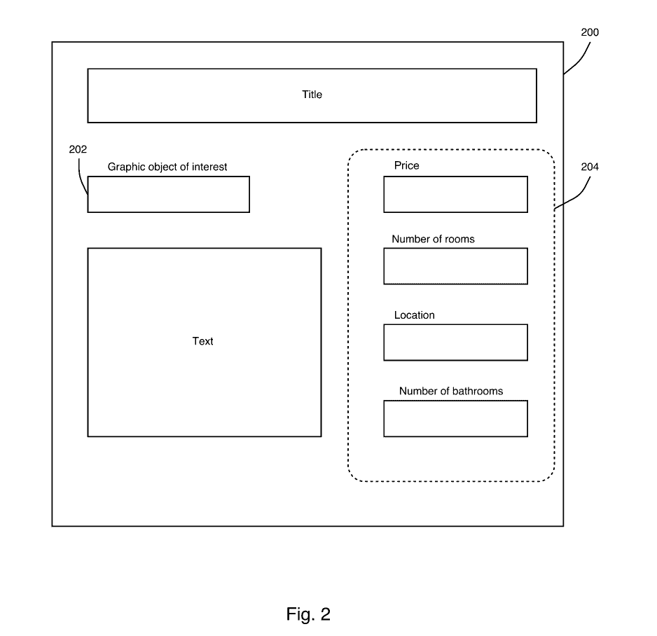

Now referring to FIG. 2, according to an embodiment, the method is available through a web site, or platform. The users 18 connect to the web site (accessible via a specific Uniform Resource Locator, a.k.a. URL, for instance) and access a web page 200 in which one or more query fields 202, 204 are available. A graphic query control having a graphic query field 202 associated therewith is provided to the user 18. The fields 202, 204, and more particularly the graphic query field 202 are embodied either as selection fields such as drop-down menus or as textual or a verbal entries, in natural language for instance, to enter conditions, parameters, and in the case of the graphic query field 202 a feature of interest of a property.

It is to be noted that the term “control” in relation with a web page herein refers to an embedded functional code installed in the web page code and that is able to perform one or more functions in relation with the web page. An example of controls includes query controls able to perform a text capture function and a data transmission function to the server. Another example is an interactive control that would allow the user to enter a “like” in relation with an image, and that like being transmitted to the server along with context data (identification of an associated image for example). Other examples of control may be environment control and behavior control that communicate to the server data on the processing environment (type of device, type of display, etc.) or data capture regarding the “local use” of the web page, for instance the path of a pointing device, duration in which the web page remains visible, and proportion of visibility of portions of the web page.

Accordingly, a control may be linked to a visible component of a web page, or be “hidden” active or not, and maybe able to be triggered voluntarily or involuntarily based on the interaction of the user with the web page.

Controls may further be described in relation with embodiments, wherein controls having a broadly interactive function are requiring an interactive button, menu or command visible to the user on the graphic user interface, regardless of the description of the embodiment specifically defining such a requirement.

Furthermore, the term “control” may refer to code transferred to the user device at one point in relation with the visit of the web site, and not specifically transferred along the code responsible for the web page to be displayed. Control code may thus apply in relation with one or more web pages relatively to a web site.

Therefore, the term control used hereinafter in relation with embodiments should encompass any functions that are linked to a web page, regardless of the control code being transferred along the web page code and regardless of the control having visual components associated therewith.

Referring back to FIG. 2, the present graphic query control pertains to visual features visible in relation with aspects of a property, such as a visual feature distinguishable in a particular room or in any room of the property.

Examples of objects of graphical query may greatly vary from wall colours, feature colours, presence of particular features such as the presence of a cooking island in the kitchen, the presence of a backsplash in the kitchen, a separate shower in a bathroom, a cathedral roof, a skylight, a covered porch, etc. The objects of a graphical query may consist in having each of these features of interest present or not in the property.

The web page may 200 optionally contain additional query controls that may be used to filter properties based on more descriptive data of the property, such as their price, location, number of rooms, number of bathrooms, etc.

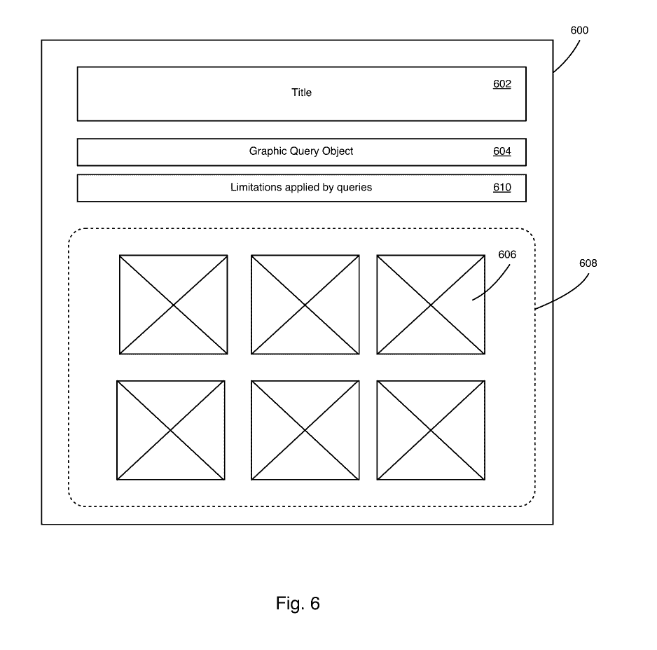

Once the user has entered the graphic query object (GQO) in the graphic query field 202 and activated the query (e.g., upon pressing the “enter” key), a query-result web page (600, visible on FIG. 6) is displayed with a mosaic of pictures of properties featuring the object of the activated graphic query (a.k.a. graphic query object or GQO) for the user 18 to be able to identify if one or more of the properties matches their desires. Accordingly, it provides the user with the opportunity of providing a representation of the graphic query object; this opportunity is advantageous since the features of interest may greatly differ from one property to another.

It is to be noted that the mosaic of pictures may take a plurality of shapes, from a single column of pictures related to a list, to a single row. Other shapes include a matrix of multiple rows and columns, a cloud-type representation and a “collage” of non-uniformly sized pictures.

It is further to be noted that even if the actual presentation of the pictures depicted here is through a mosaic, alternative depiction formats are also available to show pictures of aspects of properties visually featuring the graphic query object, such as a list.

Further, representation as a mosaic or a list defines a representation wherein order or size of the depicted pictures is determined based on an algorithm using additional data, such as the distance of the different properties versus the IP address of the user device accessing the web site, an history of use of the web site by the current user 18, values/prices of the properties, etc. to order or size each of them. Accordingly, in the present embodiment, the algorithm determines the display characteristic(s) of the images, for example the order and/or size of each picture to be displayed.

According to an embodiment, the algorithm generates a random order of pictures to be displayed in the mosaic.

According to other embodiments, the algorithm takes into account other inputs to determine display characteristics to associate to the pictures in the mosaic. Some of these inputs include, but are not limited to, the price of the property (ascending or descending), the proximity of the property relative to the location of the computing device 100 performing the search (e.g., it's IP address or GPS location), the proximity of the property relative to a location or geographic area entered as a preference by the user, the geographic location (i.e., the region, the city, province, state, district, etc. or any combination thereof), the number of rooms, the number of bathrooms, location-based features such as schools and/or parks distance, commercial area distance, etc.

The query-result web page 600, FIG. 6, presents a number of images 606 featuring in a visible manner the object of the query. By looking at the different images 606, users 18 can determine which one(s) of the properties are a better match to their interest. For instance, if the graphic query object was “cooking island”, users 18 are displayed a series of pictures of kitchens having a cooking island. So they can evaluate which one(s) presents the most potential to be interesting in view of the presence of the graphic query object, the look of the graphic query object, and the integration of the graphic query object in its environment. One must understand that, for instance, being interested in having a cooking island in the kitchen is not synonym to being interested in any cooking island, nor in not being interested in the kitchen as a whole.

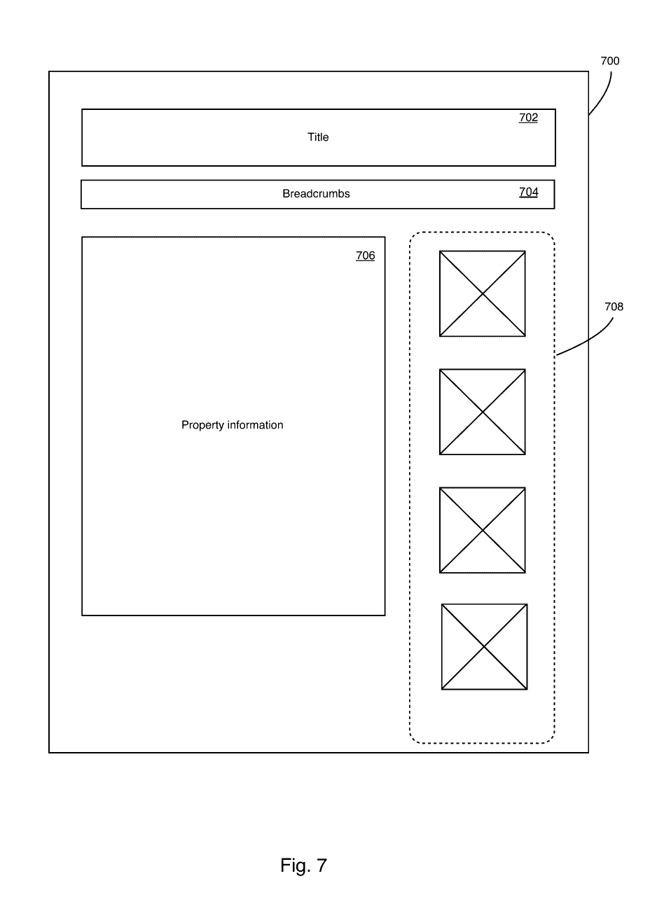

The query-result web page 600 further features a hyperlink, or other kind of control having a “server calling” functionality, associated with each of the image 606 that enables, when activated, users to gain access to the property web page 700, visible on FIG. 7, wherein the sale's information file of the property for which the picture was taken is displayed.

According to embodiments, the property web page 700 takes the form of a new web page, with this new web page being displayed either as a web page displayed in replacement of the query-result web page 600, a new generated one in addition to the previous one displayed either as a new browser tab or in a new independent window, or an overlay disposed above the query-result web page 600 for example.

According to an embodiment, by clicking on a image 606, thereby activating the associated hyperlink, the user 18 access a property web page 700 wherein a series of pictures 708 of the property are displayed, plus the general description and features of the property (property information 706), such as the price, the location, the number of rooms, the size, the year of construction, etc. Accordingly, by selecting a specific feature of interest, determining among pictures which feature pleases them, and afterwards evaluate the other characteristics of the property, users 18 are able to filter down properties more efficiently to the one(s) pleasing them.

Additional information, buttons and controls can further be integrated in the query-result web page 600, in the property web page or in an additional web page. This additional information, buttons and controls can be provided in a visible fashion, or a control-dependent fashion.

According to an additional embodiment, the query-result web page 600 features a window wherein the properties are illustrated according to their physical location on a map. Furthermore, the geolocation of properties on the map are individually identified by a “geo flag”, such as a letter, with the same geo flag being displayed in association with picture of the corresponding property in the mosaic. The geo flag on the map may further comprise an embedded control that, when activated by clicking on or hovering on the geo flag, may modify the display to illustrate the corresponding picture in the mosaic or display the corresponding mosaic picture as a temporary overlay window during the time the user keeps the pointer over the geo flag.

According to an embodiment, the query-result web page comprises one or more behavior controls that monitor the behavior of the user through the behavior of a pointing device, the part of the query-result web page displayed, etc. where the collected information is transmitted to the server. Such behavior may be used, for instance, for activating controls on the web page or for statistical data and algorithm inputs.

According to an additional embodiment, the interface code activation of a hyperlink associated with a mosaic image leads to a new web page wherein the user will get a virtual or an immersive visit of the property. Such virtual or immersive visit may take the form of a video, a series of pictures, animated or not, based on direction information provided by the user during the visit for example. Thus, the activation of the mosaic image hyperlink results in the server receiving a command associated solely with the unique entry in the database associated with the image and assembling, according to that unique entry, the requested visit (and thus the associated web page) that is sent back to the user device.

According to additional embodiments, the mosaic of pictures features highlights, which graphically identify elements such as surrounding frames of a contrasting colour. According to an embodiment, the highlights of a subset of pictures is indicative of these pictures from the subset being associated with of one specific broker, being associated with a subset of brokers, being associated with property with associated brokers, being associated with identification of a specific property agent, etc. The criteria or criterion for highlighting pictures, according to an embodiment, is defined by the server, and in another embodiment, is the subject of user controls such as an interactive box present on the query-result web page 600 allowing to highlight properties with an associated broker.

According to additional embodiments, the graphic query object the user provides can be a specific room, or a room colour, or presence of a specific material in a room such as marble, etc.

According to additional embodiments, the user is provided with controls (e.g., by hyperlink) allowing them to buy the furniture or other objects present in the pictures/images of the property. These controls may involve an Artificial Intelligence Application and/or Application Programming Interface (API) that would automatically recognize the furniture and objects and determine points of sale (e.g., website or brick and mortar establishment) where the user can purchase the furniture or objects.

According to an additional embodiment, account-owner users (a.k.a. logged in users who provided login data) have individually a database section such as a table, folder or other personal storage associated therewith. The account-owner user can mark (or save) pictures or properties via an interaction control, with the system associating the image or property to the user. Afterwards, the user may access an account web page where the marked pictures and/or properties can be displayed.

According to an additional embodiment, account-owner users are associated therewith in the database the interaction content they provide voluntarily, such as comments, like comment or “marking”, dislike comment or “marking”, ratings, etc. or involuntarily, such as the view duration or sharing of a picture on a social network.

According to an additional embodiment, the information in the account web pages is shareable by users. Accordingly, one user may share with another user their account web page for consultation by this other user.

According to another embodiment, account-owner users may perform operations on the pictures, such as adjusting image orientation, adjusting image size, new image framing, placing an annotation on the picture, placing arrows pointing out objects, adding a date to the picture(s), etc. These modifications are saved in association with the user account, permitting the user to apply a filter at some time using criteria involving such operation(s) (e.g. date associated with the modification of a picture). Some operations may further be automated, such as automatically associating a date to a picture whenever the user performs a visit of the property.

According to an embodiment, the mosaic of pictures may be the object of additional ordering or filtering by the user using a control present in the query-result web page 600. For example, the pictures may be filtered by the user to encompass or not related criteria. Dynamic filtering control can allow a user to alter the order of the pictures in the mosaic by setting the order in which the criteria are entered in the control.

According to another embodiment, the system comprises buttons and associated controls to apply filters on pictures using other non-essential tags such as modern/retro look, wood/no wood, dark/bright, type of exterior finish, etc.

According to another embodiment, the algorithm determining the display characteristics to associate with the pictures in the mosaic performs the process based on interaction content, such as popularity. Popularity may involve alone or in combination a number of “like” markings associated with the pictures, number and nature of the ratings associated with an image, the number of views of the associated visit, the number of hovering over the picture, the number of positive comments associated with the picture, etc. All of these data are comments collected through the use of interaction controls that allow associating the interaction comments to a single image by transmitting these interaction comments to the server for storage. Part of them are collected through the use of active interaction controls such as comments and the “likes”, demanding voluntary activation from the user. Others, like view duration and hovering duration, are collected through the use of passive interaction controls collecting data without patent knowledge of the user.

According to another embodiment, the user is provided with a button and associated controls allowing them to select a particular display configuration (a.k.a. to provide a display configuration consisting in a selection of a skin) for the mosaic. Thus, one user may have the same pictures present in the mosaic as another user, while having a different web page presentation. Such a skin may consist in a different Cascading Style Sheet (CSS), or a particular coding in the applied Cascading Style Sheet (CSS) with data associated with such a control determining the applicable coding in the Cascading Style Sheet (CSS) for example.

According to another embodiment, the user can add interaction content in the nature of comments associated with the picture to show their appreciation thereof. The comments can be performed in private settings (only visible by the user and/or additionally by user's invitees) or public settings (visible by anyone accessing the web site). According to an embodiment, the comments are displayed below the picture. According to another, the comments are displayed aside the picture. According to another embodiment, controls with buttons located at vicinity of or on the picture can show the number of hidden comments and may allow a user to command the display of the comments in a visible format. According to an embodiment, the hidden comments are displayed as an overlay. According to another embodiment, the hidden comments are displayed in a new frame (a.k.a. web page sub-window) in the vicinity of the picture.

According to another embodiment, the user can share pictures (or visit videos) using an existing social media network such as Facebook™, Twitter™, Pinterest™, etc. According to an embodiment, the process of sharing pictures (or visit videos) in available in the query-result web page 600 via a button associated with a social network control that is located in the vicinity of the picture. According to an embodiment, the shared picture as either associated with or embedded in the picture a hyperlink guiding someone seeing the picture on the social network to the property web page. The server, with a sharing command, shares the picture on the desired social network based on social network account data provided by the user on demand or previously provided and stored in association with the login data.

According to an embodiment, additional information on the property or on the picture is present or available to the user in the mosaic of pictures. In one embodiment, interactive content such as the number of times the picture and/or the property to which pertains the picture has been marked as “liked”, or added as a favorite is displayed beside the picture. According to an embodiment, some property information is available beside, below or somewhere above the picture. Examples of such information comprise number of bathrooms, number of rooms, presence of a garage with number of cars it may hold, etc. In an embodiment, icons with embedded numbers are used to communicate the information.

According to an embodiment, a contact control is available with an associated interactive button in the mosaic in the vicinity of the picture, over the picture, or in an overlay window associated with the picture that provides the resources to communicate with the broker in charge of the property to which pertains the picture.

According to an embodiment, a print button linked to a print control is available in the mosaic in the vicinity of the picture, over the picture, or in an overlay window associated with the picture that provides the resources to print the picture. According to another embodiment, the print command resulting from the activation of the print control automatically embeds in the printed page additional information such as property information, broker or agent contact information, date of printing, distance and travel time to visit the property based on reference location of the user, etc.

According to an embodiment, the query-result web page 600 features picture selection button(s) linked to picture selection control(s) individually associated with each picture of the mosaic. Using a plurality of the picture selection controls, a user may select a plurality of pictures before activating the printing control, with the resulting printed page(s) intended to be assembled as a folder or album. According to an embodiment, the folder or album comprises a table of content.

It must be noted that even if some additional information, buttons, processes, content and nature of the content and controls hereinabove discussed have been the object of distinct embodiments, one must understand that alternative embodiments may comprise a variety of combinations of the discussed features embodied together.

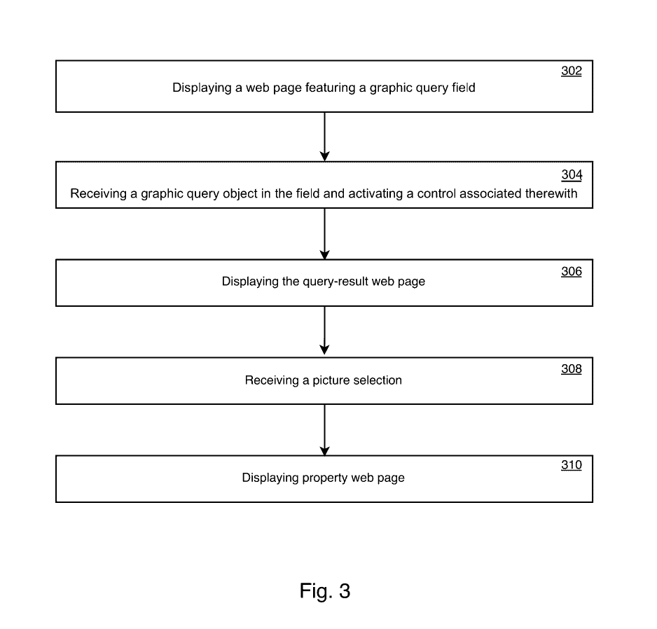

Now referring to FIG. 3, there is illustrated the steps performed according to the description above.

At Step 302, user device 16 accesses the web site, by sending an access request to the server 12 and receiving a response from the server 12 in the form a query code, and displays a web page 200 accordingly featuring a graphic query field 202.

At Step 304, user 18 enters a graphic query object and activates a control associated with the graphic query field 202, thereby sending the graphic query object to the server 12.

At Step 306, upon reception of the response to the query from the server 12, the user device 16 displays a query-result web page 600 wherein one or more images 606 are displayed visually featuring the graphic query object hence the feature of interest.

At step 308, user 18 select one or more of the images 606 as being objects of further interest, thereby activating the view button and sending the selection(s) to the server 12.

At Step 310, the user device 16 displays a property web page 700 associated with the selected picture(s).

It has to be noted that the description above of the user experience has been voluntarily kept linear for explanatory purpose. Additional features, or alternative paths may also be present. As discussed, additional query fields 204 may be present. The web site may also feature other filtering tools, help pages, home pages, hyperlinks to go directly to specific pages such as the home page, intermediary web pages, login controls allowing to personalize the experience of users and/or to save information on the users, APIs, etc. Similarly, the flow chart above is described as a series of relatively linear steps, but it does not prevent from having additional steps taking place before, in-between, or after the described steps, as having controls permitting to return to previous steps.

For illustration purpose, FIG. 6 schematically illustrates an example of query-result web page 600 wherein the title 602 of the website is provided, the graphic query object 604 provided by users is also shown as optional additional query limitations 610, to obtain query-result web page 600, images 606 with visible elements matching or related to the graphic query object according to a mosaic arrangement 608.

FIG. 7, similarly, schematically illustrates an example of a property web page 700. The property web page 700 comprises a title 702, a breadcrumbs field 704 with an associated control allowing users to return to previous web pages to change or add query entries as to modify selections. The property web page 700 further comprises property information 706 (e.g. description of the property) and property pictures 708 (e.g. a set of pictures comprising both the picture displayed in the mosaic 608 and other pictures pertaining to the property) permitting to obtain a better overview of the property as a whole. It should be noted that the property pictures 708 are normally exclusive to a single property web page 700.

### Web Site—Server Perspective

According to an embodiment, when a server 12 receives a first access request from a user device 16 having an IP address, the server 12 generates and transmits code to the user device 16 to be displayed as a web page 200. That web page 200 features a graphic query field 202.

Later, the server 12 receives a query request from the same user device 16 in which a graphic query object is identified.

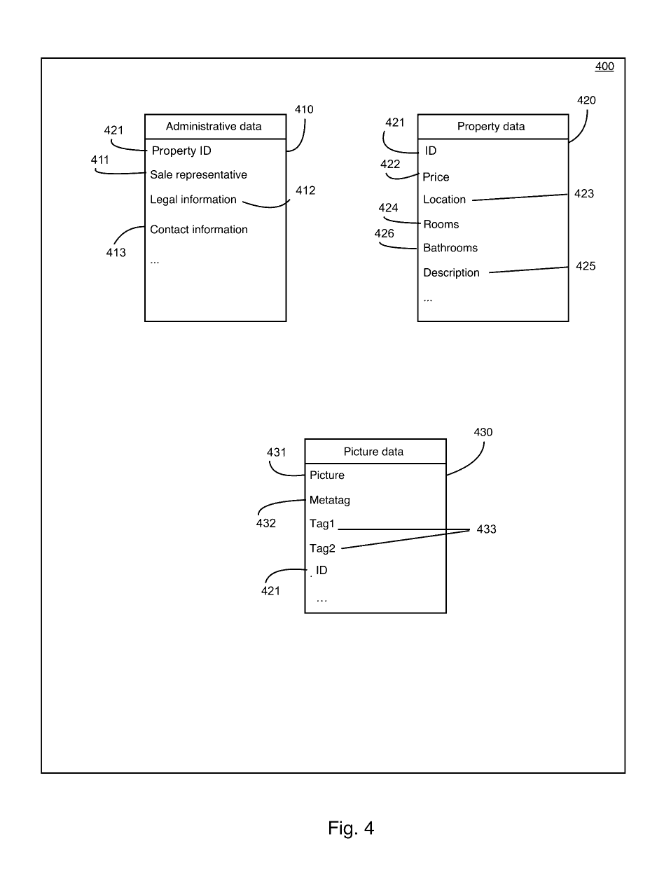

In response to the query request, the server 12 performs a query in its database of pictures (see FIG. 4) having associated a metatag uniquely identifying the property, and tags identifying the nature of the object of the picture or features that may possibly be features of interest of users depicted on the picture. By performing the query, the server 12 singles out a series of pictures which have a tag matching or related to the graphic query object. The server 12 combines the pictures, codes a response to the query request and transmits the query response to the user device 16 to be displayed as a query-result web page 600 presenting the images 606 to the users.

When receiving a signal from the user device 16 corresponding to the selection of an image 606, the server 12 generates code for the presentation of the property from which is taken the selected picture based on the metatag associated with the picture and shared by all pictures depicting the property. The server 12 then transmits the code to the user device 16 to be displayed as a property web page 700.

Accordingly, as illustrated on FIG. 4, the server 12 manages a database 400 of properties comprising tables which includes an administrative data table 410 (which comprises columns (or fields) including property id 421, sale representative 411, legal information 412, contact information 413, etc.), a property data table 420 (which comprises columns (or fields) including property id 421 (a unique key), price 422, location 423, number of rooms 424, number of bathrooms 426, description 425, etc.) and a picture data table 430 (which comprises columns (or fields) including pictures 431 (or a link thereto) each having a metatag 432 indicative of the property they are part of and other tags 433 associated therewith which are representative of features of interest characterizing the images. That database 400 is used by the server 12 to seek the desired information to respond to the queries received from user devices 16.

The unique key (property ID 421) is also found as a column in the administrative data table 410 and in the picture data table 430. A unique key is defined as a set of zero, one, or more attributes. The value(s) of these attributes are required to be unique for each tuple (row) in a relation. The value, or combination of values, of unique key attributes for any tuple should not be repeated for any other tuple in that relation. Each row in a table has its own unique key and thereby constitutes a unique entry. Rows in a table (i.e., unique entries) can be linked to rows in other tables by adding a column for the unique key of the linked row (such columns are known as foreign keys).

According to another embodiment (not shown), the database 400 is structured in a different number of tables, including one or more linkage tables each comprising linkage columns (or fields) permitting to link the information or tuple of a table to one or more tuples of another table. An exemplary use of such a linkage table consists in the use of one linkage table for linking a tag column (or field) in the picture data table 430 to one or more tag columns (or fields) (store in a tag table not illustrated) and therefore using a single tag column (or field) 433 to link an unlimited number of tags to each picture entry in the picture data table 430, hence an unlimited number of features of interest to be associated to the picture. Such a linkage table frequently include two key columns (or fields) for linking the two tables.

It is intended that in order to have pictures with an associated metatag and potential tags, there is a preparation step required that may be performed manually, through the use of an algorithm to identify objects from photographs for instance and associate tags with these pictures, or a combination thereof. Similarly, in order to face the fact that the way users express interest for a similar feature may differ, a database of synonyms, equivalent terms, related terms, and for instance relation between terms and degrees of relations may be generated beforehand and used to be able to provide these above-mentioned related pictures.

An example of the use of related pictures may consist in a query for a cooking island. The database may have stored the expressions “cooking island” and “breakfast counter” as related since both offer an additional surface to perform preparation of the dishes when cooking. As a result, the web page illustrating the resulting pictures may be divided in two sections: a first one featuring cooking islands per se, and a second one being subtitled “you may be also interested by” and illustrating kitchens visually featuring “breakfast counters”.

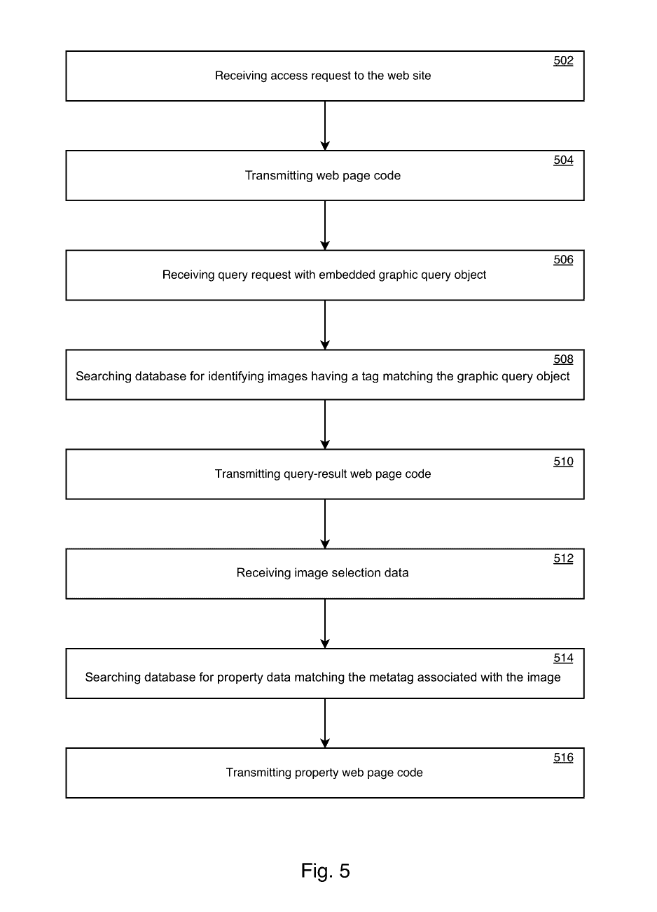

Now referring to FIG. 5, there is illustrated the steps performed by the server 12 in order to respond to the query transmitted by user devices 16.

At Step 502, the server 12 receives an access request from a user device 16.

At Step 504, the server 12 transmits code of web page 200 to the user device 16.

At Step 506, the server 12 receives a query request from the user device 16 having a graphic query object embedded therein (e.g., an embedded graphic query object).

At Step 508, the server 12 performs a search in the database 400 for identifying feature image from available on-sale properties having a tag matching, or related to, the graphic query object hence the feature of interest.

At Step 510, the server 12 generates and transmits interface code (a.k.a. query result graphic user interface code), including the feature images, to the user device 16 to be displayed as a query-result web page 600 presenting a mosaic of the feature images for the users to be able to visually evaluate them.

At Step 512, the server 12 receives a selection of a feature image from the user device 16.

At Step 514, the server 12 searches in the database for the property data to be provided to the user device 16 based on the metatag associated with the image selected by the users.

At Step 516, the server 12 generates and transmits property web page code (a.k.a. property graphic user interface code), including the property data, to the user device 16 to be displayed as a property web page 700.

It should be noted that, when the server 12 performs a step of generating and transmitting code to a user device to be displayed as a web page, the web page displayed on the user device 16 may involve code previously stored on the user device 16, previously transmitted in relation with another web page, or code used by the user device 16 to generate more than one web page. According, the discussed generated code is intended to encompass code specific to the web page but not mandatory enough by itself for the user device 16 to be able to generate the intended web page. The transmitted code may also be transmitted as a single packet or a series of packets to be combined by the user device 16 without departing from the intended scope.

Furthermore, the present process has been described with the help of screens, user-filed fields and buttons. However, one may use different screens, fields and buttons, divide the contain of one screen into a plurality of screens, combine the content of multiple screens into a single one, change the sequence of the screens or of the inputs provided by users without departing from the intended scope. The different screens, fields, buttons, and the associated screen flows have been provided as example only, in a teaching purpose, and are not intended to limit the intended scope.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A computer-implemented method for performing, on a server, an image-based search in a database comprising unique entries to which are respectively associated a unique key, the unique entries having associated thereto images which each have a tag representative of a feature characterizing the unique entries, the method comprising:
upon reception of an access request to a search graphical user interface from a user device under control of a user, transmitting querying code to the user device to display the search graphical user interface comprising a graphic query field; and
upon reception, via the graphic query field, of a query request with an embedded graphic query object indicative of a feature of interest characterizing the unique entries:
identifying images from the database having a tag matching the embedded graphic query object and hence the feature of interest; and
transmitting interface code to the user device to display an image graphical user interface comprising a mosaic including only the images which were identified in identifying step performed by the server;
wherein each one of the images in the mosaic comprises a hyperlink to a unique entry from the unique entries and further wherein images associated to a unique entry are exclusive to that unique entry.

2. The computer-implement method of claim 1, further comprising:
performing an algorithm; and
determining a display characteristic to be associated with the images of the mosaic,
wherein the display characteristic determines one of an order and a size of the images for displaying in the mosaic.

3. The computer-implement method of claim 2, further comprising:
receiving interaction content, each of the interaction content being associated with a single image; and
using the interaction content and as an input of the algorithm.

4. The computer-implement method of claim 3, wherein the interaction content comprises an active interaction content comprising one of a comment, a like comment, a dislike comment, a rating and a social network share request.

5. The computer-implement method of claim 3, wherein the interaction content comprises a passive interaction content based on at least one of a number of views, a number of hovering over with a pointing device, a duration of hovering over with the pointing device and a duration of display of the single image having the associated passive interaction content on a user device.

6. The computer-implement method of claim 1, further comprising:
receiving a social network command associated with a first one of the images for sharing the first one of the images on a social network; and
transmitting, to a server of the social network, a sharing command comprising the first one of the images and the hyperlink associated to the first one of the images.

7. The computer-implement method of claim 6, further comprising:
receiving one of social network account data and login data having social network account data associated therewith; and
including in the sharing command the social network account data.

8. The computer-implement method of claim 7, further comprising:
receiving one of social network account data and login data having social network account data associated therewith; and
including the social network account data in the sharing command.

9. The computer-implement method of claim 1, further comprising:
selecting images from the database from the images which were identified having a tag matching the embedded graphic query object as a subset of images; and
associating highlight markings with the images which are part of the subset of images;
wherein the images which are part of the subset of images and the images not part of the subset of images are displayed differently in the mosaic.

10. A computer-implemented method for performing, on a user device under control of a user and in communication with a server, an image-based search in a database comprising unique entries to which are respectively associated a unique key, the unique entries having associated thereto images which each have a tag representative of a feature of interest characterizing the unique entries, the method comprising:
displaying a search graphical user interface comprising a graphic query field;
receiving from the user, identification of a graphic query object provided through the graphic query field;
displaying an image graphical user interface comprising a mosaic comprising images;
wherein the images of the mosaic are a selection of only the images that were identified from the database having a tag matching the graphic query object and hence the feature of interest, and
wherein each image in the mosaic comprises a hyperlink to a unique entry from the unique entries and further wherein images associated to a unique entry are exclusive to that unique entry.

11. The computer-implemented method of claim 10, further comprising:
transmitting to the server the graphic query object.

12. The computer-implemented method of claim 10, further comprising:
receiving login data from a user; and
transmitting to the server the login data for the user to be logged in;
wherein the database comprises a user section; and
wherein actions performed by the user are registered in the user section of the database.

13. The computer-implemented method of claim 10, wherein the image graphical user interface comprises an interaction control, and wherein the method further comprises:
detecting use of the interaction control associated with a first one of the images from the user; and
displaying an interaction content associated with the first one of the images.

14. The computer-implemented method of claim 10, further comprising:
detecting an activation of the hyperlink associated with a first one of the images;
transmitting to the server a signal indicative of the activation of the hyperlink;
receiving, from the server, new page code based on the signal indicative of the activation of the hyperlink; and
displaying a new page using the new page code;
wherein the new page is associated with the first one of the images.

15. The computer-implemented method of claim 10, further comprising:
detecting activation of an interaction control associated with a first one of the images;
displaying an interaction interface based of activation of the interaction control;
receiving, from the user, an interaction command; and
transmitting to the server the interaction command to be registered in the database;
wherein the interaction command is one of a comment, a like, a dislike, a ranking and a social network command to share the first one of the images on a social network.

16. The computer-implemented method of claim 10, further comprising:
receiving a display configuration command;
displaying, based on the display configuration command, a second image graphical user interface comprising a mosaic of images;
wherein the image graphical user interface presents the mosaic in a first configuration and the second image graphical user interface presents the mosaic in a second configuration different from the first configuration.

17. The computer-implemented method of claim 10, further comprising:
monitoring behavior of a pointing device in relation with the image graphical user interface;
triggering activation of a behavior control based on the behavior of the pointing device fulfilling a criterion;
wherein the behavior control is associated with a first one of the images.

18. A computer-implemented system for performing an image-based search comprising:
a user device for generating an access request for content relatively to an embedded graphic query object and for displaying content associated with the embedded graphic query object;
a database comprising unique entries to which are respectively associated a unique key, the unique entries having associated thereto images which each have a tag representative of a feature of interest characterizing the unique entries;
a remote server in communication with to the user device for identifying images from the database having a tag matching the embedded graphic query object and hence the feature of interest and for transmitting interface code to the user device for displaying on the user device an image graphical user interface comprising a mosaic including only the images which were selected
wherein each one of the images in the mosaic comprises a hyperlink to a unique entry from the unique entries and further wherein images associated to a unique entry are exclusive to that unique entry.

19. The computer-implemented system of claim 18, wherein the interface code further comprises interaction controls for performing functions under control of a user in association with the images of the mosaic.

20. The computer-implemented system of claim 19, wherein the interaction controls are adapted for the user device to transmit data to the remote server.
